(19) United States
(12) Patent Application Publication
(10) Pub. No.: US 2019/0183150 A1
(43) Pub. Date: Jun. 20, 2019

(54) PROTEIN-CONTAINING BEVERAGE

(71) Applicant: Miami Bay Beverage Company, LLC, Branford, CT (US)

(72) Inventors: Casey P. Hoban, SR., Guilford, CT (US); Robert Leary, Guilford, CT (US); Peter J. Dacey, Guilford, CT (US)

(73) Assignee: Miami Bay Beverage Company, LLC, Branford, CT (US)

(21) Appl. No.: 16/108,779

(22) Filed: Aug. 22, 2018

Related U.S. Application Data
(62) Division of application No. 14/689,291, filed on Apr. 17, 2015, now abandoned.
(60) Provisional application No. 61/980,881, filed on Apr. 17, 2014.

(51) Int. Cl. A23L 2/66; A23L 2/68; A23L 2/56; A23L 2/60; A23L 2/52

(52) U.S. Cl. CPC A23L 2/66; A23L 2/68; A23L 2/52; A23L 2/60; A23L 2/56

(57) ABSTRACT

A composition and beverage including whey protein isolate; malic acid; phosphoric acid; at least one flavoring compound; a mouth feel enhancer; at least one sweetener; and a vitamin mixture.

### RELATED APPLICATIONS

This application is a divisional application claiming priority benefit of U.S. non-provisional application Ser. No. 14/689,291 filed Apr. 17, 2015, which claims priority benefit of U.S. provisional application No. 61/980,881 filed on Apr. 17, 2014 and entitled “Protein-Containing Beverage,” the entirety of which is incorporated by reference herein.

### FIELD

The current invention is directed to beverages. In particular, the current invention is directed to protein-containing beverages.

### BACKGROUND

Beverages are used to quench thirst, provide nutrients, and to accompany meals and gatherings. While many current commercially available beverages exist, most of the available beverages only provide one of the aspects mentioned above, i.e., thirst quenching or delivery of nutrients. In particular, many beverages that offer nutritional benefits, e.g., protein shakes, do not provide a consumer with a sense of refreshment, i.e., they do not quench a user's thirst. Accordingly, a consumer would need to consume several different beverages in order to get the benefits of refreshment and nutrition. As could be imagined, consumption of numerous beverages over a course of a day may be difficult, inconvenient, time-consuming and expensive. The present invention is seen to be an answer to this need.

### SUMMARY

In one aspect, the invention is directed to a protein-containing beverage, the beverage comprising: whey protein isolate; malic acid; phosphoric acid; at least one flavoring compound; a mouth feel enhancer; at least one sweetener; a vitamin mixture; and a liquid.

In another aspect, the invention is directed to a protein-containing composition comprising: whey protein isolate; malic acid; phosphoric acid; at least one flavoring compound; a mouth feel enhancer; at least one sweetener; and a vitamin mixture.

In a further aspect, the invention is directed to a process for making a protein-containing beverage, the process comprising: contacting the composition as described above with a liquid; and mixing the composition and liquid to form the protein-containing beverage.

These and other aspects of the invention are discussed in more detail in the description and appended claims.

### BRIEF DESCRIPTION OF THE DRAWING

FIG. 1 is a table listing specific ingredients of one embodiment of a protein-containing beverage.

### DETAILED DESCRIPTION

The present invention is directed to a protein-containing beverage and a protein-containing composition that is used in making a protein-containing beverage. The protein-containing beverage provides a consumer with nutritional benefits including, for example, vitamins and protein. The protein-containing beverage may also increase a consumer's metabolism, reduce a consumer's appetite and increase a consumer's energy levels. Other yet to be discovered benefits may also inure to the consumer ingesting the protein-containing beverage disclosed herein.

In one example, the protein-containing beverage includes whey protein isolate, malic acid, phosphoric acid, at least one flavoring compound, a mouth feel enhancer, at least one sweetener, a vitamin mixture, and a liquid. All of the components, i.e., ingredients, of the protein-containing beverage are appropriate for use in beverages and, if necessary, approved by the relevant regulatory authority, e.g., the Food and Drug Administration (FDA).

Whey protein isolate (often referred to as “whey isolate” or “whey protein”) is a dietary supplement and food ingredient created by separating components from milk. Whey protein isolates are defined as having >90% protein on a dry weight basis. It is contemplated that any brand of whey protein isolate may be utilized in the protein-containing beverage. In one embodiment, BiPro® whey protein from BiPro USA, may be used.

Malic acid is an organic compound with the formula HO₂CCH₂CHOHCO₂H. Malic acid is a known food additive that is commercially available and contributes to the pleasantly sour taste of fruits. Phosphoric acid (also known as orthophosphoric acid or phosphoric(V) acid) is a mineral (inorganic) acid having the chemical formula H₃PO₄. It is a commercially available food additive that is typically available in an 85% aqueous solution, which is colorless, odorless and non-volatile. Phosphoric acid is used to add acidity to foods.

Any flavoring compound may be used in the protein-containing beverage in order to impart a desired flavor profile to the beverage. The flavoring compound can be natural or artificial or a combination thereof. Examples of flavoring compounds that may be used in the protein-containing beverage include lime flavor, lemon flavor, strawberry flavor, cherry flavor, raspberry flavor, orange flavor, panela flavor, watermelon flavor, tropical berry flavor, pina colada flavor, grape flavor or a combination of any of the foregoing.

The at least one sweetener may be any natural sweetener or artificial sweetener, and may also be a combination of both natural sweeteners and artificial sweeteners. The sweetener may be sucrose, glucose, fructose, sorbitol, mannitol, corn syrup, erythritol, high fructose corn syrup, stevia, monkfruit, pure cane sugar, saccharin, aspartame, sucralose, acesulfame potassium (acesulfame-K), neotame, or a combination of any of the foregoing.

As mentioned above, consumers are looking for a convenient manner to refresh themselves and ingest nutrients. Many consumers lack certain vitamins in their diet and thus look to supplements to obtain such nutrients. Accordingly, in one embodiment the protein-containing beverage includes a vitamin mixture. The vitamin mixture may include one or more types of vitamins that are desired by consumers, such as, for example, Vitamin A (beta-carotene), Vitamin Bp (choline), Vitamin B₁ (thiamin), Vitamin B₂ (riboflavin, vitamin G), Vitamin B₃ (niacin, vitamin P, vitamin PP), Vitamin B₅ (pantothenic acid), Vitamin B₆ (pyridoxine, pyridoxamine, or pyridoxal), Vitamin B₇ (biotin, vitamin H), Vitamin B₉ (folic acid, folate, vitamin M), Vitamin B₁₂ (cobalamin), Vitamin C (ascorbic acid), Vitamin D (ergocalciferol, or cholecalciferol), Vitamin E (tocopherol), and Vitamin K (naphthoquinoids). In one embodiment, the vitamin mixture includes Vitamin B₃, Vitamin B₅, Vitamin B₆, and Vitamin B₁₂.

It is also contemplated that the protein-containing beverage includes one or more dietary minerals, such as, for example, calcium, Chloride, Chromium, Cobalt (as part of Vitamin B₁₂), Copper, Iodine, Iron, Magnesium, Manganese, Molybdenum, Phosphorus, Potassium, Selenium, Sodium, and Zinc. Additionally, it is also contemplated that the protein-containing beverage includes one or more amino acids such as Isoleucine, Lysine, Leucine, Methionine, Phenylalanine, Threonine, Tryptophan, Valine and Histidine.

In one embodiment the protein-containing beverage does not include any food safe coloring agent. In another embodiment, the protein-containing beverage includes at least one food safe coloring agent. Examples of food safe coloring agents include all color additives approved for use by the FDA. Specific examples include, but are not limited to, FD&C Blue No. 1, FD&C Blue No. 2, FD&C Green No. 3, Orange B, Citrus Red No. 2, FD&C Red No. 3, FD&C Red No. 40, FD&C Yellow No. 5 and FD&C Yellow No. 6.

The protein-containing beverage may include a mouth feel enhancer. Mouth feel enhancers are known in the art and it is contemplated that any mouth feel enhancer can be utilized in the protein-containing beverage. An example includes natural mouth feel enhancer MOU815L, but the invention is not limited to this particular example.

The protein-containing beverage includes a liquid. The liquid may be any type suitable for a beverage and includes, but is not limited to still water, tea, coffee, carbonated water, alcohol (for example, vodka, rum, gin, wine, beer, a malt-based alcoholic beverage, and the like) or a combination of any of the foregoing.

In one embodiment, the protein-containing beverage may include the whey protein isolate, malic acid, phosphoric acid, at least one natural flavoring compound, a mouth feel enhancer, a vitamin mixture, a naturally occurring sweetener and a liquid. Examples of natural sweeteners include, but are not limited to pure cane sugar, stevia and erythritol.

In another embodiment, it is contemplated that the protein-containing beverage includes the whey protein isolate, malic acid, phosphoric acid, at least one natural flavoring compound, a vitamin mixture, a sweetener and a liquid. A food safe color agent may be added thereto.

It is contemplated that the components of the protein-containing beverage may be combined in any manner and in any order. In one embodiment, the protein-containing beverage is made in a master batch and then divided into smaller portions. In one example, the whey protein isolate is added to a mixing tank containing water and mixed with a high speed mixer. Optionally, an anti-foam additive is added to the protein-containing mixture to reduce the amount of foam. Additional water is added followed by the addition of at least one food safe coloring agent, phosphoric acid, and malic acid. The pH of the mixture is measured after the malic acid is added and additional phosphoric acid may be added to achieve the desired pH level. Finally the flavoring compound, vitamin mixture and at least one sweetener are added to the mixture.

In one embodiment, the protein-containing beverage includes whey protein isolate in an amount of about 1.6 wt. %, malic acid in an amount of about 0.19 wt. %, phosphoric acid in an amount of about 0.12 wt. %, at least one flavoring compound in an amount of about 0.1 wt. %, the mouth feel enhancer in an amount of about 0.02 wt. %, at least one sweetener in an amount of about 0.01 wt. %, vitamin mixture in an amount of about 0.02 wt. % and liquid in an amount of about 98 wt. % wherein the wt. % are based on the total wt. % of the protein-containing beverage. In another embodiment of the foregoing formulation of the protein-containing beverage, it is contemplated that one or more food safe coloring agent can be added to the protein-containing beverage in any amount desired.

The protein-containing beverage is not limited to the foregoing specific amounts of the ingredients since it is contemplated that the formulation of the protein-containing beverage can be modified as desired by manufacturer.

It is contemplated that the protein-containing beverage can be sold to the consumer as a pre-mixed beverage. However, it is also contemplated that a protein-containing composition can be provided in order for the consumer to mix their own beverage. The protein-containing composition may be provided in powder or syrup form.

In one embodiment, the protein-containing composition includes whey protein isolate, malic acid, phosphoric acid, at least one flavoring compound, a mouth feel enhancer, at least one sweetener; and a vitamin mixture, which are all discussed in more detail above. It is also contemplated that the protein-containing composition also contain, in addition to the foregoing ingredients, at least one dietary mineral and/or at least one amino acid, as described in more detail above. One or more food safe coloring agents may be added to the protein-containing composition if desired.

A particular example of a protein-containing composition includes, in one embodiment, the whey protein isolate, malic acid, phosphoric acid, at least one natural flavoring compound, a mouth feel enhancer, a vitamin mixture and a naturally occurring sweetener. Examples of natural sweeteners include, but are not limited to pure cane sugar, stevia and erythritol.

Another particular example of a protein-containing composition includes whey protein isolate, malic acid, phosphoric acid, at least one flavoring compound, at least one sweetener; and a vitamin mixture. One or more food safe coloring agents may be added thereto.

In one embodiment, the protein-containing beverage is made by contacting the protein-containing composition with a liquid and mixing the protein-containing composition and liquid to form the protein-containing beverage. The mixing can be accomplished by any known method including shaking or blending either manually or with a machine, i.e., a blender.

The following example is in accordance with the present invention and is not meant to limit the invention in any manner.

### EXAMPLE

### Example 1—Key Lime Flavor Protein-Containing Beverage

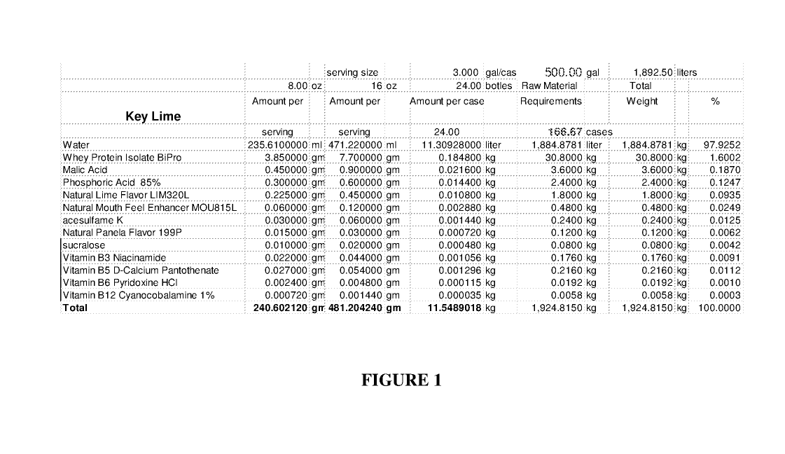

FIG. 1 provides a specific formulation of a protein-containing beverage according to the present invention.

To obtain the beverage of Example 1, add whey protein isolate to mixing tank containing 500 gallons of water. Mix the water and whey protein isolate with a high speed mixture, e.g., a Breddo mixer. To the mixture of the water and whey protein isolate, add 8 oz. of anti-foam additive, e.g., anti-foam FG10 (500 gm) or FG 30 Dow antifoam (150 gm). Add remaining amount of water to the mixing tank. Add phosphoric acid to mixing tank. (If food safe color agent is desired, it may be added to the mixing tank prior to the addition of the phosphoric acid).

Following the addition of the phosphoric acid, malic acid is added and the pH level is read. If the pH is above 2.8, add one (1) quart of phosphoric acid until the pH reached between 3.4 and 3.8. After pH is read, add flavor, vitamin mix, acesulfame K and sucralose.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A protein-containing beverage, the beverage comprising:
whey protein isolate;
malic acid;
phosphoric acid;
at least one flavoring compound;
a mouth feel enhancer;
at least one sweetener;
a vitamin mixture; and
a liquid.

2. The protein-containing beverage according to claim 1, wherein said at least one flavoring compound is selected from the group consisting of lime flavor, lemon flavor, strawberry flavor, cherry flavor, raspberry flavor, orange flavor, panela flavor, watermelon flavor, tropical berry flavor, pina colada flavor, grape flavor and a combination of any of the foregoing.

3. The protein-containing beverage according to claim 1, wherein said at least one sweetener is selected from a group consisting of sucrose, glucose, fructose, sorbitol, mannitol, corn syrup, high fructose corn syrup, pure cane sugar, monkfruit, stevia, erythritol, saccharin, aspartame, sucralose, acesulfame potassium (acesulfame-K), neotame, and a combination of any of the foregoing.

4. The protein-containing beverage according to claim 1, wherein said vitamin mixture comprises at least one of Vitamin B₃, Vitamin B₅, Vitamin B₆, and Vitamin B₁₂.

5. The protein-containing beverage according to claim 1, further comprising at least one food safe coloring agent.

6. The protein-containing beverage according to claim 1, wherein said liquid is selected from a group consisting of still water, tea, coffee, carbonated water, alcohol and a combination of any of the foregoing.

7. The protein-containing beverage according to claim 1, wherein said whey protein isolate is present in an amount of about 1.6 wt. %, said malic acid is present in an amount of about 0.19 wt. %, said phosphoric acid is present in an amount of about 0.12 wt. %, said at least one flavoring compound present in an amount of about 0.1 wt. %, said mouth feel enhancer present in an amount of about 0.02 wt. %, said at least one sweetener present in an amount of about 0.01 wt. %, said vitamin mixture is present in an amount of about 0.02 wt. % and said liquid is present in an amount of about 98.00 wt. % based on a total wt. % of the protein-containing beverage.

8. A protein-containing composition comprising:
whey protein isolate;
malic acid;
phosphoric acid;
at least one flavoring compound;
a mouth feel enhancer;
at least one sweetener; and
a vitamin mixture.

9. The protein-containing composition according to claim 8, wherein said at least one flavoring compound is selected from the group consisting of lime flavor, lemon flavor, strawberry flavor, cherry flavor, raspberry flavor, orange flavor, panela flavor, watermelon flavor, grape flavor and a combination of any of the foregoing.

10. The protein-containing composition according to claim 8, wherein said at least one sweetener is selected from a group consisting of sucrose, glucose, fructose, sorbitol, mannitol, corn syrup, high fructose corn syrup, pure cane sugar, stevia, erythritol, saccharin, aspartame, sucralose, acesulfame potassium (acesulfame-K), neotame, and a combination of any of the foregoing.

11. The protein-containing composition according to claim 8, wherein said vitamin mixture comprises at least one of Vitamin B₃, Vitamin B₅, Vitamin B₆, and Vitamin B₁₂.

12. The protein-containing composition according to claim 8, further comprising at least one food safe coloring agent.
